(19) United States
(12) Patent Application Publication
(10) Pub. No.: US 2002/0044373 A1
(43) Pub. Date: Apr. 18, 2002

(54) Magnetic recording/reproducing apparatus having a chassis made of a magnetic material

(75) Inventor: Ikuichiro Nawa, Atsugi-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Mitsumi Electric Co. Ltd., Tokyo (JP)

(21) Appl. No.: 09/975,465

(22) Filed: Oct. 10, 2001

(30) Foreign Application Priority Data
Oct. 12, 2000 (JP) 312132/2000

(51) Int. Cl. G11B 15/00

(52) U.S. Cl. 360/96.1

(57) ABSTRACT

A chassis for use in a magnetic recording/reproducing apparatus on which first and second reel motors are mounted is made of a magnetic material having a magnetic shielding effect. The chassis may comprise a plate made of an irony magnetic material which press working is performed or may being made of cast iron. The chassis may be made by injection molding of the magnetic material. In addition, the first and second reel motors may comprise inner rotor type motors which have a common structure.

### BACKGROUND OF THE INVENTION

This invention relates to a magnetic recording/reproducing apparatus (or a tape drive) such as a linear tape storage system represented by DLT (digital liner tape) or LTO (linear tape open) and, in particular, to structure of a chassis for mounting a real motor therein.

Linear tape storage systems (magnetic recording/reproducing apparatus) of the type described are developed as “back-up” systems for hard disks of computer systems and various types of the linear tape storage systems have been proposed in prior art. For example, a digital linear tape drive serving as the DLT is disclosed in U.S. Pat. No. 5,862,014 to Nute, entitled “Multi-Channel Magnetic Tape Head Module Including Flex Circuit” or the like.

The digital linear tape drive (which may be merely called “driving apparatus”, “tape drive”, or “drive”) is for receiving a tape cartridge (which may be merely called “cartridge”) having a single reel (a supply reel) and contains a take-up reel therein. When the tape cartridge is installed in the driving apparatus, a magnetic tape is pulled out of the tape cartridge and then is wound by the take-up reel through a head guide assembly (HGA). The head guide assembly is for guiding the magnetic tape (which may be merely called “tape”) pulled out of the tape cartridge in a magnetic head. The magnetic head exchanges information between the tape and the magnetic head. The head guide assembly generally comprises a boomerang-shaped aluminum plate and six large guide rollers each using a bearing.

In addition, the head guide assembly is also called a tape guide assembly which is disclosed, for example, in U.S. Pat. No. 5,414,585 to Saliba, entitled “Rotating Tape Edge Guide.” In addition, an example of the guide roller is disclosed in Japanese Unexamined Patent Publication Tokkai No. 2000-100025 or JP 2000-100025 A.

The tape drive is generally comprised of a rectangular housing that has a common base as described, for example, in U.S. Pat. No. 5,793,574, entitled “Tape Head Actuator Assembly Having A Shock Suppression Sleeve” to Cranson et al. The base has two spindle motors (reel motors). The first spindle motor has a spool (or a take-up reel) permanently mounted on the base and the spool is dimensioned to accept a relatively high speed streaming magnetic tape. The second spindle motor (reel motor) is adapted to accept a removable tape cartridge. The removable tape cartridge is manually or automatically inserted into the drive via a slot formed on the drive's housing. Upon insertion of the tape cartridge into the slot, the cartridge engages the second spindle motor (reel motor). Prior to rotation of the first and the second spindle motors, the tape cartridge is connected to the permanently mounted spool (the take-up reel) by means of a mechanical buckling mechanism. A number of rollers (guide rollers) positioned intermediate the tape cartridge and the permanent spool guide the magnetic tape as it traverses at relatively high speeds back and forth between the tape cartridge and the permanently mounted spool.

In the digital linear tape drive having such a structure, an apparatus for pulling the tape from the supply reel to the take-up reel is required. Such as a pulling apparatus is disclosed, for example, in International Publication Number WO 86/07471. According to WO 86/07471, take up leader means (a first tape leader) is coupled to the take-up reel while supply tape leader means (a second tape leader) is connected to the tape on the supply reel. The first tape leader has one end formed into a mushroom like tab. The second tape leader has a locking aperture. The tab is engaged into the locking aperture.

Furthermore, a mechanism for joining the first tape leader with the second tape leader is required. Such a joining mechanism is disclosed, for example, in International Publication number WO 86/07295.

In addition, Japanese Unexamined Patent Publication Tokkai No. 2000-100116 or JP 2000-100116 A discloses a structure of leader tape engaging part which can engage an end part of a leader tape (the second tape leader) to a tape end hooking part in a tape cartridge without requiring a tab projected in the side of the leader tape.

U.S. Pat. No. 5,857,634, entitled “Take-up Reel Lock” to Hertrich discloses a locking system for preventing a take-up reel of a tape drive from rotating when a tape cartridge is not inserted to the drive.

In addition, the tape drive further comprises a tape head actuator assembly which is located between a take-up spool and a tape cartridge on a tape path defined by a plurality of rollers. During operation, a magnetic tape flows forward and backward between the take-up spool and the tape cartridge and is closely adjacent to the tape head actuator assembly while the magnetic tape flows on the defined tape path. An example of such as a tape head actuator assembly is disclosed in the above-mentioned U.S. Pat. No. 5,793,574.

On the other hand, an example of the tape cartridge installed in the digital linear tape drive is disclosed in Japanese Unexamined Patent Publication Tokkai No. 2000-149491 or JP 2000-149491 A.

In addition, U.S. Pat. No. 6,241,171, entitled “Leaderless Tape Drive” to Gaboury discloses a tape drive wherein a tape leader from a tape cartridge is urged through a tape path, into a take-up reel, and secured therein without the use of a bucking mechanism or a take-up leader.

As described above, the tape drive comprises the first and the second reel motors which are mounted on a chassis. In addition, each of the first and the second reel motors generally comprises an inner-rotor type motor. In conventional technique, the chassis is made, by die-casting, of aluminum which is non-magnetic material.

As described above, a conventional chassis is made of aluminum by die-casting. Inasmuch as aluminum is non-magnetic material, it is impossible in a conventional magnetic recording/reproducing apparatus of shielding magnetic leakage from the first and the second reel motors. In order to shield the magnetic leakage from the reel motor, the conventional magnetic recording/reproducing apparatus must use a magnetic plate. It may be possible to avoid effect of the magnetic leakage by sufficiently widening distances between the first and the second reel motors and a magnetic tape or a magnetic head. However, such a structure disturbs miniaturization and thinning. Furthermore, the chassis made of aluminum by die-casting is expensive.

### SUMMARY OF THE INVENTION

It is therefore an object of the present invention to provide a magnetic recording/reproducing apparatus and a chassis for use therein, which are capable of perfectly shielding magnetic leakage from reel motors to a magnetic tape or a magnetic head without use of a plate made of a magnetic material.

It is another object of the present invention to provide a magnetic recording/reproducing apparatus of the type described, which is capable of achieving miniaturization and thinning.

It is still another object of the present invention to provide a magnetic recording/reproducing apparatus of the type described, in which reel motors of a take-up side and a supply side have a common structure.

It is yet another object of the present invention to provide a magnetic recording/reproducing apparatus and a chassis for use therein, which are capable of reducing costs.

Other objects of this invention will become clear as the description proceeds.

On describing the gist of a first aspect of this invention, it is possible to be understood that a magnetic recording/reproducing apparatus comprises a chassis having an upper surface and a lower surface. The upper surface is divided into first and second upper areas. The lower surface is divided into first and second lower areas which are opposite to the first and the second upper areas, respectively. A take-up reel is rotatably mounted on the first upper area of the chassis. Mounted on the first lower area of the chassis, a first reel motor rotatably drives the take-up reel. A slot portion is disposed on the second upper area of the chassis. A cartridge is inserted in the slot portion. The cartridge comprises a rotatable supply reel and a magnetic tape being wound around the supply reel. Mounted on the second lower area of the chassis, a second reel motor rotatably drives the supply reel when the cartridge is inserted in the slot portion. The magnetic tape is pulled from the supply reel to be wound around the take-up reel. A magnetic head carries out information exchange between the magnetic tape and the magnetic head. According to the first aspect of this invention, the chassis is made of a magnetic material having a magnetic shielding effect.

On describing the gist of a second aspect of this invention, it is possible to be understood that a chassis is for use in a magnetic recording/reproducing apparatus comprising first and second reel motors mounted on the chassis. According to the second aspect of this invention, the chassis is made of a magnetic material having a magnetic shielding effect.

In the above-mentioned magnetic recording/reproducing apparatus and the above-mentioned chassis, the chassis preferably may comprise a plate made of an irony magnetic material which press working is performed. In addition, the chassis may be made of cast iron. Furthermore, the chassis may be made by injection molding of the magnetic material. In addition, in the above-mentioned magnetic recording/reproducing apparatus, the first and the reel motors desirably may comprise inner rotor type motors which have a common structure.

### BRIEF DESCRIPTION OF THE DRAWING

FIG. 1 is an exploded perspective view showing a conventional magnetic recording/reproducing apparatus including a conventional chassis;

FIG. 2 is a plan view showing the conventional magnetic recording/reproducing apparatus illustrated in FIG. 1;

FIG. 3 is a sectional view taken substantially along the lines III-III of FIG. 2;

FIG. 4 is an exploded perspective view showing a magnetic recording/reproducing apparatus including a chassis according to an embodiment of this invention;

FIG. 5 is a plan view showing the magnetic recording/reproducing apparatus illustrated in FIG. 4: and

FIG. 6 is a sectional view taken substantially along the lines VI-VI of FIG. 5.

### DESCRIPTION OF THE PREFERRED EMBODIMENT

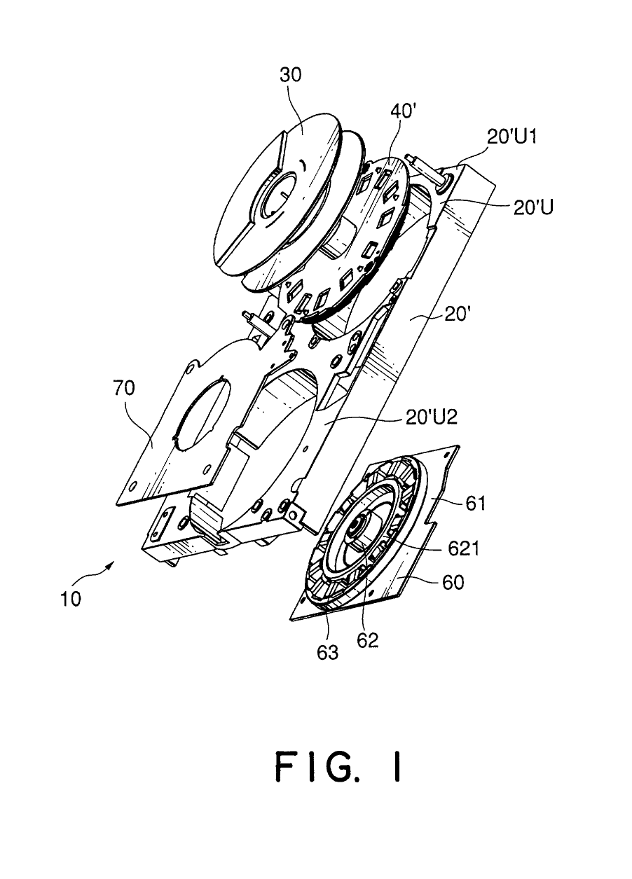

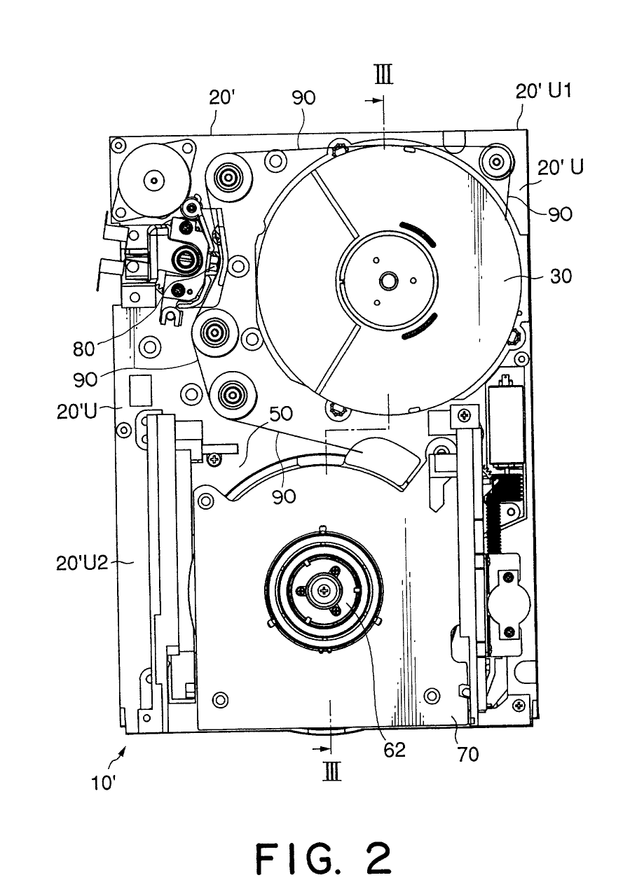

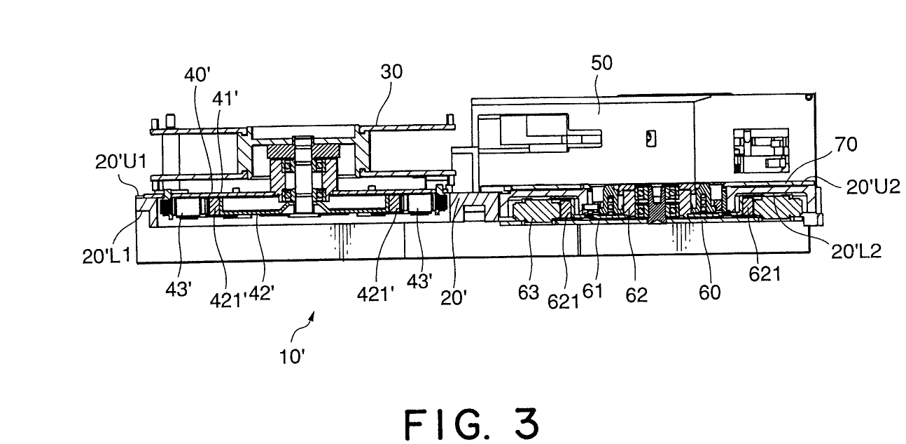

Referring to FIGS. 1, 2, and 3, a conventional magnetic recording/reproducing apparatus including a conventional chassis will be described at first in order to facilitate an understanding of the present invention. FIG. 1 is an exploded perspective view showing the conventional magnetic recording/reproducing apparatus depicted at 10′ including the conventional chassis depicted at 20′. FIG. 2 is a plan view showing the conventional magnetic recording/reproducing apparatus 10′ illustrated in FIG. 1. FIG. 3 is a sectional view taken substantially along the lines III-III of FIG. 2.

The magnetic recording/reproducing apparatus 10′ comprises the chassis 20′ having an upper surface 20′U and a lower surface 20′L. The chassis 20′ is made, by die casing, of aluminum which is a non-magnetic material. The upper surface 20′U is divided into a first upper area 20′U1 and a second upper area 20′U2. Likewise, the lower surface 20′L is divided into a first lower area 20′L1 and a second lower area 20′L2 which are opposite to the first upper area 20′U1 and the second upper area 20′U2, respectively.

In addition, the magnetic recording/reproducing apparatus 10′ further comprises a take-up reel 30, a first reel motor 40′, a slot portion 50, a second reel motor 60. The first reel motor 40′ is called a take-up reel motor while the second reel motor 60 is called a supply reel motor.

The take-up reel 30 is rotatably mounted on the first upper area 20′U1 of the chassis 20′. The first reel motor (the take-up reel motor) 40′ is mounted on the first lower area 20′L2 of the chassis 20′ and is a motor for rotatably driving the take-up reel 30. As shown in FIG. 3, the first reel motor 40′ comprises a first motor board 41′ made of a magnetic material, a first rotor 42′ rotatably mounted on the first motor board 41′, and a first stator 43′ fixedly mounted on the first motor board 41′. The first reel motor 40′ comprises an inner-rotor type motor where the first rotor 42′ is disposed inside the first stator 43′. The first rotor 42′ comprises a first ring-shaped magnet 421′.

On the other hand, the slot portion 50 is formed on the second upper area 20′U2 of the chassis 20′. In the slot portion 50, a cartridge (not shown) is inserted. The cartridge comprises a rotatably supply reel (not shown) and a magnetic tape 90 wound around the supply tape. The second reel motor (the supply reel motor) 60 is mounted on the second lower area 20′L2 of the chassis 20′ and is a motor for rotatably driving the above-mentioned supply reel when the above-mentioned cartridge is inserted in the slot portion 50. The second reel motor 60 comprises a second motor board 61 made of a magnetic material, a second rotor 62 rotatably mounted on the second motor board 61, and a second stator 63 fixedly mounted on the second motor board 61. The second reel motor 60, in the manner of the first reel motor 40′, comprises an inner-rotor type motor where the second rotor 62 is disposed inside the second stator 63. The second rotor 62 comprises a second ring-shaped magnet 621.

As is apparent from FIGS. 1 and 3, the first reel motor (the take-up reel motor) 40′ is disposed with the first reel motor turned upside down for the second reel motor (the supply reel motor) 60. In other words, in the first reel motor 40′, the first rotor 42′ and the first stator 43′ are disposed on a lower surface side of the first motor board 41′. In the second reel motor 60, the second rotor 62 and the second stator 63 are disposed on an upper surface side of the second motor board 61. Accordingly, the second reel motor 60 is put into a state where the second ring-shaped magnet 621 of the second rotor 62 is exposed to the outside. Inasmuch as the second ring-shaped magnet 621 has strong magnetism, the second reel motor 60 is covered with a plate 70 made of ironic magnetic material in order to shield magnetic leakage.

With the magnetic recording/reproducing apparatus 10′ having such as structure, it is possible to carry out information exchange between the magnetic head 80 and a magnetic tape 90 which is pulled out of the supply reel and which is then wound around the take-up reel 30.

As described above, the conventional chassis 20′ is made of aluminum by die-casting. Inasmuch as aluminum is non-magnetic material, it is impossible in the conventional magnetic recording/reproducing apparatus 10′ of shielding magnetic leakage from the first and the second reel motors 40′ and 60. It may be possible to avoid effect of the magnetic leakage by sufficiently widening distances between the first and the second reel motors 40′ and 60 and the magnetic tape 90 or the magnetic head 80. However, such a structure disturbs miniaturization and thinning, as mentioned in the preamble of the instant specification.

In particularly, inasmuch as the inner-rotor type motor is used as each of the first reel motor 40′ and the second reel motor 60, the ring-shaped magnets 421′ and 621 having the strong magnetism are exposed to the outside. Accordingly, the conventional magnetic recording/reproducing apparatus 10′ shields the magnetic leakage from the first and the second reel motors 40′ and 60 to the magnetic tape 90 or the magnetic head 80 by covering the second reel motor 60 with the magnetic plate 70 and by changing structure and installation between the first reel motor 40′ and the second reel motor 60.

Furthermore, the chassis 20′ made of aluminum by die-casting is expensive, as also mentioned in the preamble of the instant specification.

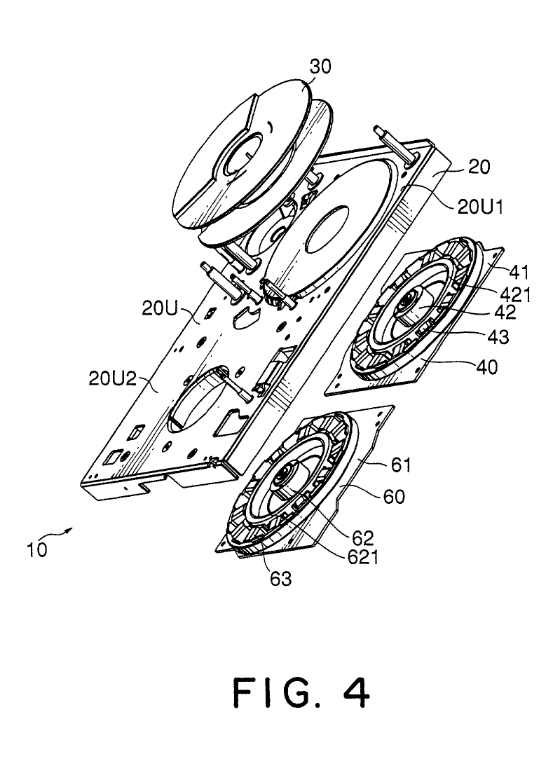

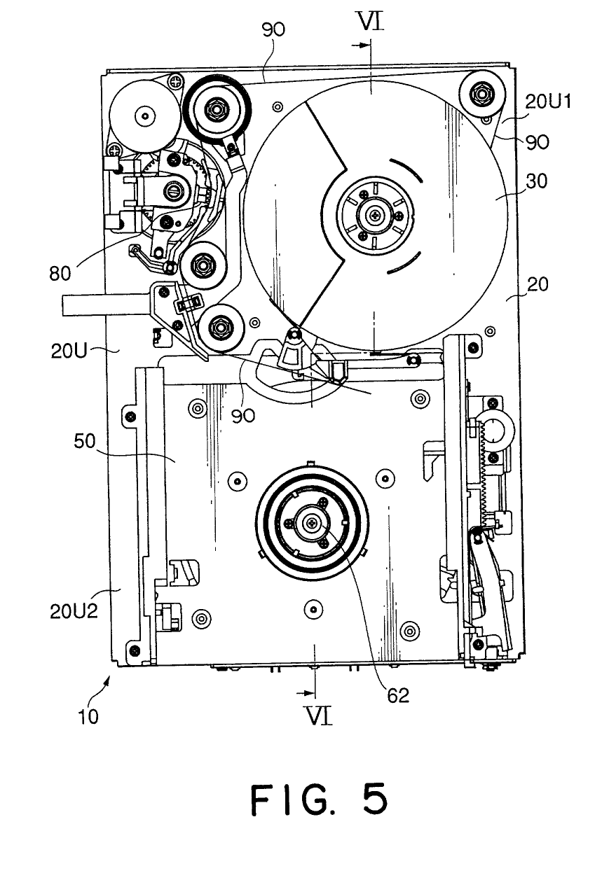

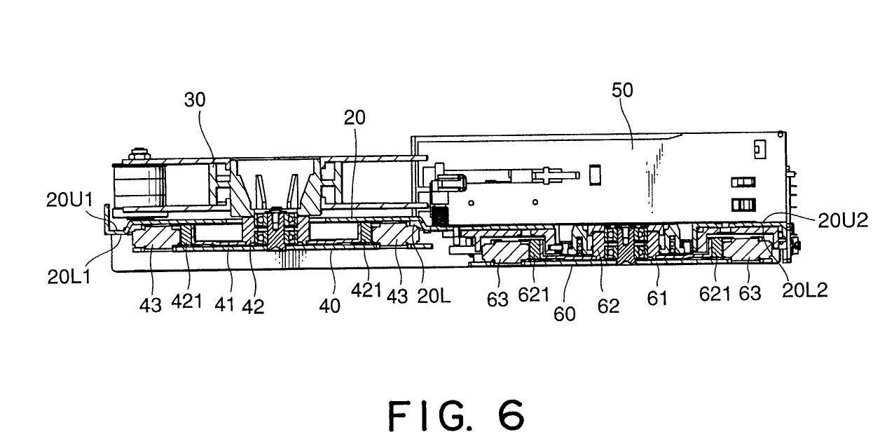

Referring to FIGS. 4 through 6, the description will proceed to a magnetic recording/reproducing apparatus including a chassis according an embodiment of this invention. FIG. 4 is an exploded perspective view showing the magnetic recording/reproducing apparatus depicted at 10 including the chassis depicted at 20 according to this invention. FIG. 5 is a plan view showing the magnetic recording/reproducing apparatus 10 illustrated in FIG. 4. FIG. 6 is a sectional view taken substantially along the lines VI-VI of FIG. 5.

The magnetic recording/reproducing apparatus 10 comprises the chassis 20 having an upper surface 20U and a lower surface 20L. The chassis 20 comprises a plate made of an irony magnetic material which press working is performed. The upper surface 20U is divided into a first upper area 20U1 and a second upper area 20U2. Similarly, the lower surface 20L is divided into a first lower area 20L1 and a second lower area 20L2 which are opposite to the first upper area 20U1 and the second upper area 20U2, respectively.

In addition, the magnetic recording/reproducing apparatus 10 further comprises a take-up reel 30, a first reel motor 40, a slot portion 50, a second reel motor 60. The first reel motor 40 is called a take-up reel motor while the second reel motor 60 is called a supply reel motor.

The take-up reel 30 is rotatably mounted on the first upper area 20U1 of the chassis 20. The first reel motor (the take-up reel motor) 40 is mounted on the first lower area 20L2 of the chassis 20 and is a motor for rotatably driving the take-up reel 30. As shown in FIGS. 4 and 6, the first reel motor 40 comprises a first motor board 41 made of a magnetic material, a first rotor 42 rotatably mounted on the first motor board 41, and a first stator 43 fixedly mounted on the first motor board 41. The first reel motor 40 comprises an inner-rotor type motor where the first rotor 42 is disposed inside the first stator 43. The first rotor 42 comprises a first ring-shaped magnet 421.

On the other hand, the slot portion 50 is formed on the second upper area 20U2 of the chassis 20. In the slot portion 50, a cartridge (not shown) is inserted. The cartridge comprises a rotatably supply reel (not shown) and a magnetic tape 90 wound around the supply tape. The second reel motor (the supply reel motor) 60 is mounted on the second lower area 20L2 of the chassis 20 and is a motor for rotatably driving the above-mentioned supply reel when the above-mentioned cartridge is inserted in the slot portion 50. The second reel motor 60 comprises a second motor board 61 made of a magnetic material, a second rotor 62 rotatably mounted on the second motor board 61, and a second stator 63 fixedly mounted on the second motor board 61. The second reel motor 60, in the manner of the first reel motor 40, comprises an inner-rotor type motor where the second rotor 62 is disposed inside the second stator 63. The second rotor 62 comprises a second ring-shaped magnet 621.

As is apparent from FIGS. 4 and 6, the first reel motor (the take-up reel motor) 40 and the second reel motor (the supply reel motor) 60 have a common structure. That is, in the first reel motor 40, the first rotor 42 and the first stator 43 are disposed on an upper surface side of the first motor board 41. Likewise, in the second reel motor 60, the second rotor 62 and the second stator 63 are disposed on an upper surface side of the second motor board 61. Accordingly, both of the first reel motor 40 and the second reel motor 60 are put into a state where the first ring-shaped magnet 421 of the first rotor 42 and the second ring-shaped magnet 621 of the second rotor 62 are exposed to the outside.

As is apparent from FIGS. 4 and 6, inasmuch as both of the first ring-shaped magnet 421 and the second ring-shaped magnet 621 are covered with the chassis 20 made of the magnetic material, it is possible to shield magnetic leakage.

With the magnetic recording/reproducing apparatus 10 having such as structure, it is possible to carry out information exchange between the magnetic head 80 and a magnetic tape 90 which is pulled out of the supply reel and which is then wound around the take-up reel 30.

As described above, inasmuch as the magnetic recording/reproducing apparatus according to this embodiment comprises, as the chassis 20, a chassis comprising a plate made of an irony magnetic material which press working is performed, it is possible to reduce the cost of the chassis 20 itself in comparison with the conventional chassis 20′. In addition, it is possible to perfectly shield magnetic leakage from the first and the second reel motors 40 and 60 to the magnetic tape 90 or the magnetic head 80 by making the best use of a specific characteristic in the ionic magnetic material of the chassis 20. As a result, it is possible to achieve miniaturization and thinning of the magnetic recording/reproducing apparatus 10 because it is possible to be close distances between the first and the second reel motors 40 and 60 and the magnetic tape 90 or the magnetic head 80. In addition, inasmuch as the first reel motor 40 of the take-up reel 30 side and the second reel motor 60 of the supply reel side may be comprised so as to have the common structure, it is possible to further reduce costs of the magnetic recording/reproducing apparatus 10.

While this invention has thus far been described in conjunction with a preferred embodiment thereof, it is to be understood that modifications will be apparent to those skilled in the art without departing from the spirit of the invention. For example, although the above-mentioned embodiment uses, as the chassis 20, the chassis comprising the plate made of the irony magnetic material which press working is performed, it is possible to achieve the magnetic shielding effect by using, as the chassis 20, one made of cast iron or one made by injection molding of the magnetic material.

What is claimed is:

1. A magnetic recording/reproducing apparatus comprising:
a chassis having an upper surface and a lower surface, said upper surface being divided into first and second upper areas, said lower surface being divided into first and second lower areas which are opposite to the first and the second upper areas, respectively, said chassis being made of a magnetic material having a magnetic shielding effect;
a take-up reel rotatably mounted on the first upper area of said chassis;
a first reel motor, mounted on the first lower area of said chassis, for rotatably driving said take-up reel;
a slot portion, disposed on the second upper area of said chassis, in which a cartridge is inserted, said cartridge comprising a rotatable supply reel and a magnetic tape being wound around said supply reel;
a second reel motor, mounted on the second lower area of said chassis, for rotatably driving said supply reel when said cartridge is inserted in said slot portion, the magnetic tape being pulled from said supply reel to be wound around said take-up reel; and
a magnetic head for carrying out information exchange between said magnetic tape and said magnetic head.

2. A magnetic recording/reproducing apparatus as claimed in claim 1, wherein said chassis comprises a plate made of an irony magnetic material which press working is performed.

3. A magnetic recording/reproducing apparatus as claimed in claim 1, wherein said chassis is made of cast iron.

4. A magnetic recording/reproducing apparatus as claimed in claim 1, wherein said chassis is made by injection molding of the magnetic material.

5. A magnetic recording/reproducing apparatus as claimed in claim 1, wherein said first and second reel motors comprise inner rotor type motors which have a common structure.

6. A chassis for use in a magnetic recording/reproducing apparatus comprising first and second reel motors mounted on said chassis, wherein said chassis is made of a magnetic material having a magnetic shielding effect.

7. A chassis as claimed in claim 6, wherein said chassis comprises a plate made of an irony magnetic material which press working is performed.

8. A chassis as claimed in claim 6, wherein said chassis is made of cast iron.

9. A chassis as claimed in claim 6, wherein said chassis is made by injection molding of the magnetic material.
